(19) United States
(12) Patent Application Publication
(10) Pub. No.: US 2011/0204863 A1
(43) Pub. Date: Aug. 25, 2011

(54) Power Regulator System and Method

(76) Inventor: John R. Spencer, Fort Collins, CO (US)

(21) Appl. No.: 12/708,905

(22) Filed: Feb. 19, 2010

(51) Int. Cl. G05F 1/10

(52) U.S. Cl. 323/282

(57) ABSTRACT

A power regulator system and method are provided. In one embodiment, a power regulator system comprises a voltage regulator configured to generate a regulator voltage at a regulator node based on a feedback voltage and an output stage configured to generate a run voltage at a run voltage node and a standby voltage at a standby voltage node based on the regulator voltage. The system also comprises a mode control stage configured to set the power regulator system in one of a run mode and a standby mode in response to a mode signal and a feedback control stage configured to provide the feedback voltage based on the run voltage in the run mode and based on the standby voltage in the standby mode.

### BACKGROUND

Certain electronic systems accommodate several energy saving power states to allow energy conservation when the electronic system is not running. As an example, the energy saving states can include a standby mode. Circuit chips can implement both a run voltage and a standby voltage in a run mode and the standby voltage in an energy saving standby mode.

### BRIEF DESCRIPTION OF THE DRAWINGS

FIG. 1 illustrates an example embodiment of a power regulator system.

FIG. 2 illustrates another example embodiment of a power regulator system.

FIG. 3 illustrates an example embodiment of a timing diagram associated with a power regulator system.

FIG. 4 illustrates an example embodiment of a method for regulating a run voltage and a standby voltage of a power regulator system.

### DETAILED DESCRIPTION

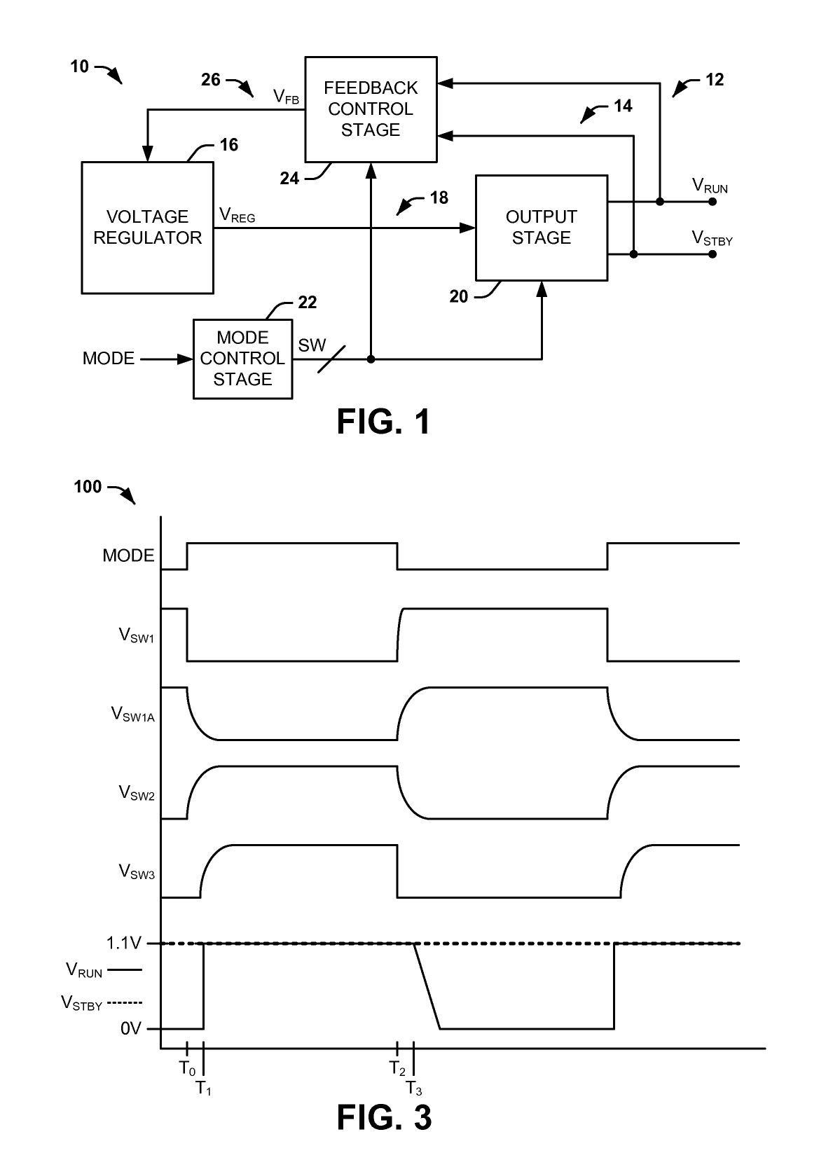

FIG. 1 illustrates an example of a power regulator system 10. The power regulator system 10 is configured to generate a run voltage V_{RUN} at a run voltage node 12 and a standby voltage V_{STBY} at a standby voltage node 14. As an example, the run voltage V_{RUN} can be implemented to provide power to active electronic applications that provide a higher conducting load (e.g., approximately 10-14 A) in a run mode and the standby voltage V_{STBY} can be provided in both the run mode and the standby mode to provide power to background electronic applications that provide a relatively smaller conducting load (e.g., approximately 2 A).

The power regulator system 10 includes a voltage regulator 16 that is configured to generate a regulator voltage V_{REG} at a regulator voltage node 18 in response to a feedback voltage V_{FB}. As an example, the voltage regulator 16 can be configured as a switching regulator, such as a buck regulator. The regulator voltage V_{REG} is provided to an output stage 20 that is configured to generate the run voltage V_{RUN} and the standby voltage V_{STBY} based on the regulator voltage V_{REG}. As an example, the output stage 20 can include a set of low on-resistance switches that interconnect the run voltage node 12 and the standby voltage node 14 with a regulator voltage node in series. As a result, the run voltage V_{RUN} and the standby voltage V_{STBY} can both have a magnitude that is approximately equal to the regulator voltage V_{REG} (e.g., approximately 1.1 V).

The power regulator system 10 also includes a mode control stage 22. The mode control stage 22 is configured to generate one or more control signals SW in response to a mode control signal MODE. As an example, the mode control signal MODE can be externally provided to switch the power regulator system 10 between the run mode and the standby mode. For example, the mode control signal MODE can be a digital signal having a logic-high state (e.g., 3.3 V) that is indicative of the run mode and a logic-low state (e.g., 0 V) that is indicative of the standby mode. The control signals SW are provided to the output stage 20 to set the magnitudes of the run voltage V_{RUN} and the standby voltage V_{STBY}. As an example, in the run mode, the associated electronic system may be running any of a variety of active electronic applications, and thus may require a significant amount of current, as well as one or more lower current intensity background applications. Thus, in the run mode, the control signals SW can control the output stage 20 to provide both the run voltage V_{RUN} and the standby voltage V_{STBY}. However, in the standby mode, the control signals SW can control the output stage 20 to disable the run voltage V_{RUN} to conserve power, thus forcing the run voltage V_{RUN} to an approximately zero magnitude, while maintaining the standby voltage V_{STBY}.

The power regulator system also includes a feedback control stage 24. The feedback control stage 24 is configured to generate the feedback voltage V_{FB} at a feedback node 26 in response to one of the run voltage V_{RUN} and the standby voltage V_{STBY,} depending on the mode in which the power regulator system 10 is set. Specifically, in the example of FIG. 1, the feedback control stage 24 is demonstrated as receiving the control signals SW, such that the feedback control stage 24 is generate the feedback voltage V_{FB} from the run voltage V_{RUN} in the run mode and from the standby voltage V_{STBY} in the standby mode. As an example, the feedback control stage 24 can include a combination of switches and/or resistors that are configured to set a feedback path from the run voltage node 12 to the feedback node 26 in the run mode and from the standby voltage node 14 to the feedback node 26 in the standby mode. Therefore, the power regulator system 10 can accurately regulate both of the output voltages based on the corresponding mode to which the power regulator system 10 is set.

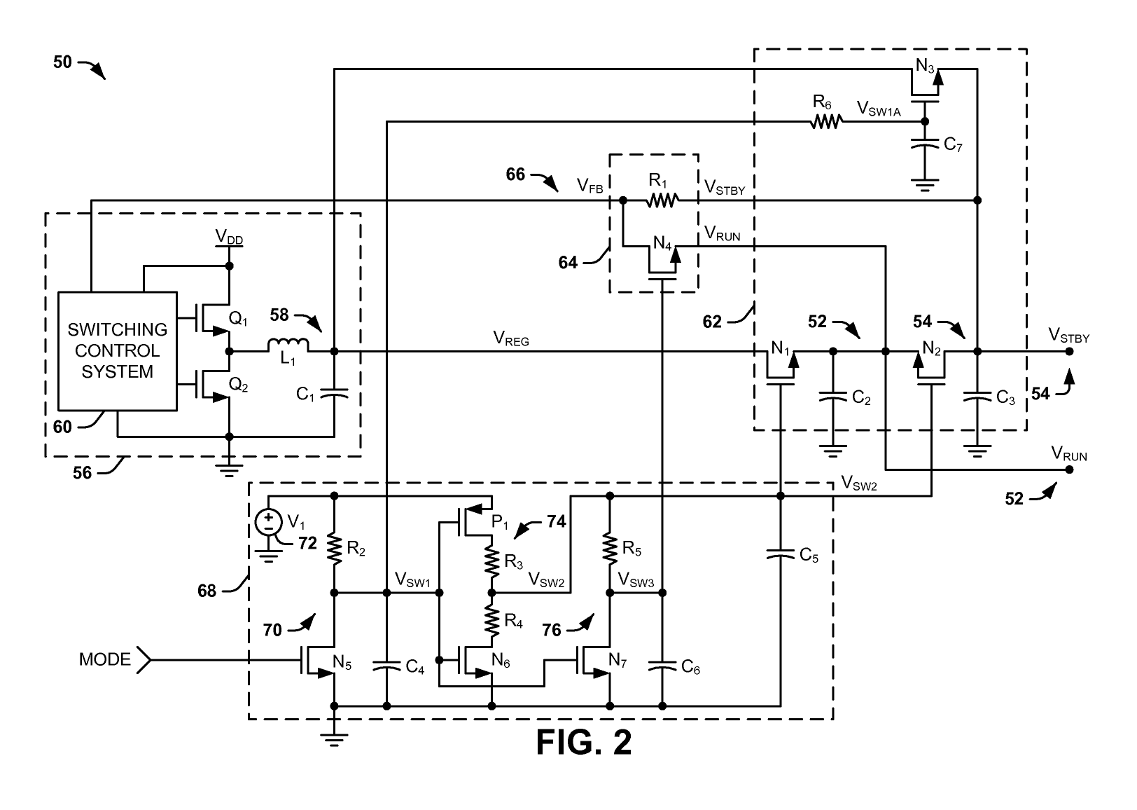

FIG. 2 illustrates another example of a power regulator system 50. The power regulator system 50 is configured to generate a run voltage V_{RUN} at a run voltage node 52 and a standby voltage V_{STBY} at a standby voltage node 54. The power regulator system 50 includes a voltage regulator 56 that is configured to generate a regulator voltage V_{REG} at a regulator voltage node 58 in response to a feedback voltage V_{FB}. In the example of FIG. 2, the voltage regulator 56 is configured as a buck switching regulator. The voltage regulator 56 thus includes a switching control system 60 that is configured to generate control signals to activate a first N-type field effect transistor (FET) Q₁ and a second N-FET Q₂ arranged between a supply voltage V_{DD} (e.g., 12 V) and ground. Thus, the voltage regulator 56 is configured to generate the regulator voltage V_{REG} at an output of an inductor L₁ across a capacitor C₁ based on a switching duty-cycle that is set in response to the feedback voltage V_{FB}.

The regulator voltage V_{REG} is provided to an output stage 62 that is configured to generate the run voltage V_{RUN} and the standby voltage V_{STBY} based on the regulator voltage V_{REG}. In the example of FIG. 2, the output stage 62 includes a first output switch N₁, a second output switch N₂, and a third output switch N₃, demonstrated in the example of FIG. 2 as N-FETs. The first output switch N₁ is demonstrated as interconnecting the regulator voltage node 58 and the run voltage node 52 and the second output switch N₂ is demonstrated as interconnecting the run voltage node 52 and the standby voltage node 54. The second output switch N₂ is demonstrated as having a drain coupled to the standby voltage node 54 to substantially mitigate body diode conduction when the gate of the second output switch N₂ is driven low. The third output switch N₃ is demonstrated as interconnecting the regulator voltage node 58 and the standby voltage node 54. In addition, the output stage 62 includes a first output capacitor C₂ and a second output capacitor C₃ coupled to the run voltage node 52 and the standby voltage node 54, respectively, that provide further regulation of the run voltage V_{RUN} and the standby voltage V_{STBY}.

As described in greater detail below, the output switches N₁, N₂, and N₃ can be operated to provide both the run voltage V_{RUN} and the standby voltage V_{STBY} in the run mode and to provide only the standby voltage V_{STBY} in the standby mode. In addition, the output switches N₁, N₂, and N₃ can each be fabricated to have a low on-resistance. As an example, the output switches N₁ and N₃ can have an on-resistance that is sufficiently low to keep power dissipation of the power regulator system 50 to within specification (e.g., as required by user). However, the on-resistance of the output switch N₃ can be greater than the on-resistance of the output switch N₁ based on the difference in magnitude of the current associated with the run voltage V_{RUN} (e.g., approximately 10-14 A) relative to the magnitude of the current associated with the standby voltage V_{STBY} (e.g., approximately 2 A). As another example, the on-resistance of the output switch N₂ can be sufficiently low to minimize the voltage across the output switch N₂ (e.g., approximately 10 mV) from the run voltage V_{RUN} to the standby voltage V_{STBY.} As a result, in the run mode, the run voltage V_{RUN} and the standby voltage V_{STBY} can both have a magnitude that is approximately equal to the regulator voltage V_{REG} (e.g., approximately 1.1 V) and with minimum conduction losses in the run mode due to higher conducting loads. However, due to the arrangement of the output switches N₁, N₂, and N₃, in the standby mode, the run voltage V_{RUN} can have a magnitude that is approximately zero while the standby voltage can be maintained at the magnitude that is approximately equal to the regulator voltage V_{REG}.

The power regulator system also includes a feedback control stage 64. The feedback control stage 64 is configured to generate the feedback voltage V_{FB} at a feedback node 66 in response to one of the run voltage V_{RUN} and the standby voltage V_{STBY,} depending on the mode in which the power regulator system 50 is set. In the example of FIG. 2, the feedback control stage 64 includes a feedback switch N₄ that interconnects the run voltage node 52 and the feedback node 66 and a resistor R₁ that interconnects the standby voltage node 54 and the feedback node 66. As an example, the resistor R₁ can have a resistance magnitude (e.g., 100Ω) that is significantly less than a scaling feedback resistor (not shown) that can be implemented in the switching control system 60, but also significantly greater than an on-resistance of the feedback switch N₄ (e.g., 2Ω). As described in greater detail below, based on the arrangement of the feedback switch N₄ and the resistor R₁, the feedback voltage V_{FB} can be generated based on either the run voltage V_{RUN} in the run mode or the standby voltage V_{STBY} in the standby mode.

The power regulator system 50 also includes a mode control stage 68. The mode control stage 68 is configured to receive a mode control signal MODE that, in the example of FIG. 2, is externally provided to switch the power regulator system 50 between the run mode and the standby mode. For example, the mode control signal MODE can be a digital signal having a logic-high state (e.g., 3.3 V) that is indicative of the run mode and a logic-low state (e.g., 0 V) that is indicative of the standby mode. The mode control signal MODE is provided to a first inverter 70 that is formed by a resistor R₂ and an N-FET N₅. The first inverter 70 is demonstrated in the example of FIG. 2 as powered by a voltage source 72 that provides a voltage V₁ (e.g., 12 V). The first inverter 70 provides an output that is a first control voltage V_{SW1} across a capacitor C₄.

The first control voltage V_{SW1} is provided as an input to a second inverter 74 and a third inverter 76. The second inverter 74 is formed from a P-FET P₁ and an N-FET N₆ and which is likewise powered by the voltage V₁. In addition, the second inverter 74 includes resistors R₃ and R₄ that interconnect the P-FET P₁ and the N-FET N₆, respectively, with the output of the second inverter 74. The second inverter 74 thus inverts the first control voltage V_{SW1} to generate a second control voltage V_{SW2} across a capacitor C₅. The third inverter 76 is formed from a resistor R₅ and an N-FET N₇ and which is powered by the second control voltage V_{SW2}. The third inverter 76 thus likewise inverts the first control voltage V_{SW1} to generate a third control voltage V_{SW3} across a capacitor C₆.

In the example of FIG. 2, the first control voltage V_{SW1} is provided to a resistor R6 to generate a voltage V_{SW1A} across a capacitor C₇. As an example, the resistor R6 can have a large magnitude (e.g., 100 kΩ). The voltage V_{SW1A} thus controls the third output switch N₃. The voltage V_{SW1A} therefore tracks the state of the first control voltage V_{SW1}, but with more gradual transitions based on the RC time constant of the resistor R6 and the capacitor C₇. The second control voltage V_{SW2} is provided to both the first and second output switches N₁ and N₂, thus controlling the activation and deactivation of the first and second output switches N₁ and N₂. The second control voltage V_{SW2} is an inverted version of the first control voltage V_{SW1}, and thus tracks an opposite state of the first control voltage V_{SW1}. However, similar to the voltage V_{SW1A}, the second control voltage V_{SW2} has more gradual transitions.

In addition, the third control voltage V_{SW3} is provided to the feedback switch N₄ to activate and deactivate the feedback switch N₄ to set the feedback path based on the mode in which the power regulator system 50 is set. Because the third inverter 76 inverts the first control voltage V_{SW1} and is powered by the second control voltage V_{SW2}, and based on the RC time constant that is set by the resistor R₅ and the capacitor C₆, the magnitude of the third control voltage V_{SW3} can have a faster fall time and a delayed rise time relative to the second control voltage V_{SW2}. As a result, the power regulator system 50 can accurately regulate the run voltage V_{RUN} and the standby voltage V_{STBY} and can ensure substantially no change in the regulator voltage V_{REG} during transitions between the run mode and the standby mode.

FIG. 3 illustrates an example of a timing diagram 100 associated with a power regulator system. As an example, the timing diagram 100 can correspond to operation of the power regulator system 50 in the example of FIG. 2. Therefore, reference is to be made to the example of FIG. 2 in the following description of the example of FIG. 3. Specifically, the timing diagram 100 demonstrates the relative timing between the mode control signal MODE, the mode control voltages V_{SW1}, V_{SW2}, and V_{SW3}, the voltage V_{SW1A}, the run voltage V_{RUN} (demonstrated as a solid line), and the standby voltage V_{STBY} (demonstrated as a dashed line).

At a time T₀, the mode control signal MODE is asserted to a logic-high state to indicate a transition from the standby mode to the run mode. In response, the first inverter 70 sinks the first control voltage V_{SW1} to ground via the N-FET N₅ to rapidly set the first control voltage V_{SW1} to approximately zero volts. As a result, the first control voltage V_{SW1} activates the P-FET P₁ in the second inverter 74 and the second control voltage V_{SW2} begins to slowly rise at the time T₀ based on the building of charge in the capacitor C₅ from the voltage source 72 through the P-FET P₁ and the resistor R₃. In addition, the voltage V_{SW1A} begins to slowly fall at the time T₀ due to the discharge of the capacitor C₇. At a time T₁, just subsequent to the time T₀, the third control voltage V_{SW3} begins to slowly rise based on the delay caused by the third inverter 76 being powered by the slowly rising second control voltage V_{SW2} and the RC time constant of the resistor R₅ and the capacitor C₆.

Based on the increase of the second control voltage V_{SW2} beginning at the time T₀, the first and second output switches N₁ and N₂ are activated. Thus, the run voltage node 52 becomes coupled to the regulator node 58 via the first output switch N₁ and the run voltage node 52 becomes coupled to the standby voltage node 54. As a result, in the example of FIG. 3, the run voltage V_{RUN} increases to approximately 1.1 volts at a time just subsequent to the time T₀. It is to be understood that the increase of the run voltage V_{RUN} being demonstrated as approximately the time T₁ is approximate, and thus does not necessarily coincide with the delay of the third inverter 76. In addition, the standby voltage V_{STBY} is maintained at approximately 1.1 volts. It is to be understood that the first and second output switches N₁ and N₂ can have a low on-resistance, such that the run voltage V_{RUN} and the standby voltage V_{STBY} can differ by a negligible magnitude (e.g., 10 mV).

In the example of FIG. 3, the voltage V_{SW1A} and the second control voltage V_{SW2} are approximately symmetrical and opposite in phase based on the inherent delays that are caused by the combination of the resistor R6 and the capacitor C₇ and by the second inverter 74 relative to the first control voltage V_{SW1}. As a result, the first and second output switches N₁ and N₂ are activated before the third output switch N₃ is deactivated. In addition, because the third control voltage V_{SW3} has a rise time that is delayed relative to the second control voltage V_{SW2}, the first and second output switches N₁ and N₂ are likewise activated before the feedback switch N₄ is activated. As a result, the regulator voltage V_{REG} substantially does not change in the transition from the standby mode to the run mode.

The activation of the feedback switch N₄ thus sets a feedback path for the power regulator system 50 from the run voltage node 52 to the feedback node 58 through the feedback switch N₄. Therefore, in the run mode, the power regulator system 50 regulates the run voltage V_{RUN} and the standby voltage V_{STBY} based on the run voltage V_{RUN.} It is to be understood that, based on the resistance of the resistor R₁ and the magnitude of the standby voltage V_{STBY} relative to the magnitude of the run voltage V_{RUN}, the contribution of the standby voltage V_{STBY} to the feedback voltage V_{FB} through the resistor R₁ in the run mode is substantially negligible, such that the magnitude of the regulator output V_{REG} does not change in the transition from the standby mode to the run mode.

At a time T₂, the mode control signal MODE is de-asserted to a logic-low state to indicate a transition from the run mode to the standby mode. In response, the N-FET N₅ in the first inverter 70 is deactivated to rapidly set the first control voltage V_{SW1} to approximately 12 volts. As a result, the first control voltage V_{SW1} deactivates the P-FET P₁ and activates the N-FET N₆ in the second inverter 74 and the N-FET N₇ in the third inverter 76. As a result, the second control voltage V_{SW2} begins to slowly fall at the time T₂ based on the discharge of the capacitor C₅ through the resistor R₄ and the N-FET N₆ in the second inverter 74 and the resistor R₅ and the N-FET N₇ in the third inverter. In addition, the voltage V_{SW1A} begins to slowly rise at the time T₂ due to the charging of the capacitor C₇. Furthermore, as described above, the third control voltage V_{SW3} has a rapid fall time relative to the second control voltage V_{SW2}. Therefore, at the time T₂, the third control voltage V_{SW3} rapidly falls to a magnitude of approximately zero volts based on the activation of the N-FET N₇.

Based on the decrease of the second control voltage V_{SW2} beginning at the time T₂, the first and second output switches N₁ and N₂ become deactivated. However, based on the approximately symmetrical and opposite in phase of the voltage V_{SW1A} and the second control voltage V_{SW2} relative to the first control voltage V_{SW1}, the third output switch N₃ is activated before the first and second output switches N₁ and N₂ are deactivated. In addition, because the third control voltage V_{SW3} has a rapid fall time relative to the second control voltage V_{SW2}, the feedback switch N₄ is likewise deactivated before the first and second output switches N₁ and N₂ are deactivated. As a result, the regulator voltage V_{REG} substantially does not change in the transition from the standby mode to the run mode.

Upon deactivation of the first and second output switches N₁ and N₂, as well as the feedback switch N₄, the run voltage node 52 becomes decoupled from the regulator node 58 and from the standby voltage node 54. As a result, in the example of FIG. 3, the run voltage V_{RUN} decreases to approximately zero volts at a time T₃ subsequent to the time T₂. In addition, the standby voltage V_{STBY} is maintained at approximately 1.1 volts. Specifically, the feedback loop of the power regulator system 50 adjusts the voltage across the third output switch N₃, such that, in the standby mode, the standby voltage V_{STBY} has a magnitude that is the same as the magnitude of the run voltage V_{RUN} in the run mode (i.e., differing from the regulator voltage by a negligible magnitude).

The deactivation of the feedback switch N₄ thus sets a feedback path for the power regulator system 50 from the standby voltage node 54 to the feedback node 58 through the resistor R₁. Therefore, in the standby mode, the power regulator system 50 regulates the standby voltage V_{STBY} based on the standby voltage V_{STBY} itself. Accordingly, the standby voltage V_{STBY} can be accurately regulated in the standby mode without a substantial change in magnitude relative to the run mode.

It is to be understood that the power regulator system 50 is not intended to be limited to the example of FIG. 2. As an example, the voltage regulator 56 is not limited to being configured as a buck switching converter, but could be any of a variety of voltage regulators. As another example, additional configurations of the circuit components of the mode control stage 68 can be implemented to generate the mode control voltages V_{SW1}, V_{SW2}, and V_{SW3} to provide the mode selection control and order of switching of the feedback switch N₄ and the output switches N₁, N₂, and N₃. Accordingly, the power regulator system 50 can be configured in any of a variety of ways.

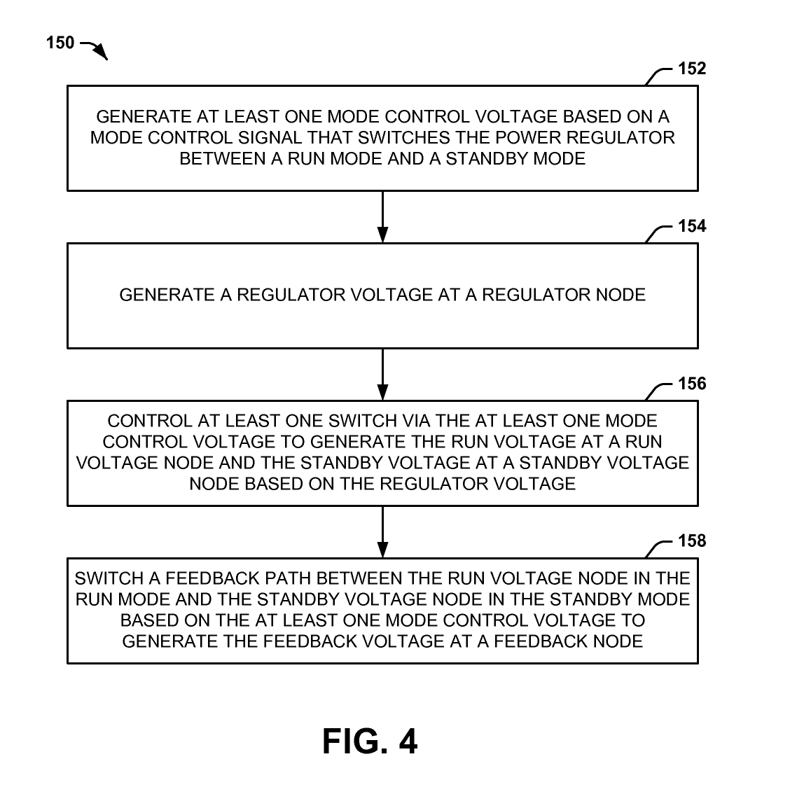

In view of the foregoing structural and functional features described above, a methodology in accordance with various aspects of the present invention will be better appreciated with reference to FIG. 4. While, for purposes of simplicity of explanation, the methodology of FIG. 4 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 4 illustrates an example of a method 150 for regulating a run voltage and a standby voltage of a power regulator system. At 152, at least one mode control voltage is generated based on a mode control signal that switches the power regulator between a run mode and a standby mode. At 154, a regulator voltage is generated at a regulator node based on a feedback voltage. At 156, at least one output switch is controlled via the at least one mode control voltage to generate the run voltage at a run voltage node and the standby voltage at a standby voltage node based on the regulator voltage. At 158, a feedback path is switched between the run voltage node in the run mode and the standby voltage node in the standby mode based on the at least one mode control voltage to generate the feedback voltage at a feedback node

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A power regulator system comprising:
a voltage regulator configured to generate a regulator voltage at a regulator node based on a feedback voltage;
an output stage configured to generate a run voltage at a run voltage node and a standby voltage at a standby voltage node based on the regulator voltage;
a mode control stage configured to set the power regulator system in one of a run mode and a standby mode in response to a mode signal; and
a feedback control stage configured to provide the feedback voltage based on the run voltage in the run mode and based on the standby voltage in the standby mode.

2. The system of claim 1, wherein the output stage comprises:
a first output switch interconnecting the regulator node and the run voltage node; and
a second output switch interconnecting the run voltage node and the standby voltage node, the first and second output switches being activated based on the mode control stage in the run mode to provide the run voltage and the standby voltage based on the regulator voltage, the first and second output switches being deactivated based on the mode control stage in the standby mode to set the run voltage to approximately zero.

3. The system of claim 2, wherein the output stage further comprises a third output switch that interconnects the regulator node and the standby voltage node, the third output switch being activated in the standby mode via the mode control stage to provide the standby voltage in the standby mode based on the regulator voltage.

4. The system of claim 1, wherein the feedback control stage comprises:
a feedback switch that interconnects the run voltage node and a feedback node that is held at the feedback voltage, the feedback switch being activated in the run mode via the mode control stage to generate the feedback voltage based on the run voltage; and
a resistor that interconnects the standby voltage node and the feedback node.

5. The system of claim 4, wherein the mode control stage is configured to generate a first control voltage that activates at least one output switch in the output stage to generate the run voltage based on the regulator voltage in the run mode, the mode control stage also being configured to generate a second control voltage having a delayed rise time and faster fall time relative to the first control voltage, the second control voltage activating the feedback switch subsequent to the activation of the at least one output switch in the run mode and deactivating the feedback switch prior to the deactivation of the at least one output switch in the standby mode.

6. A method for regulating a run voltage and a standby voltage of a power regulator system, the method comprising:
generating a regulator voltage at a regulator node based on a feedback voltage;
generating a run voltage at a run voltage node and a standby voltage at a standby voltage node based on the regulator voltage;
generating a mode control signal that switches the power regulator between a run mode and a standby mode; and
switching a feedback path between the run voltage node in the run mode and the standby voltage node in the standby mode based on the mode control signal to generate the feedback voltage at a feedback node.

7. The method of claim 6, wherein generating the run voltage and the standby voltage comprises:
activating a first output switch interconnecting the regulator node and the run voltage node and a second output switch interconnecting the run voltage node and the standby voltage node in the run mode; and
deactivating the first and second output switches to set the run voltage to approximately zero in the standby mode.

8. The method of claim 6, wherein switching the feedback path comprises:
activating a feedback switch to set the feedback path from the run voltage node to the feedback node via the feedback switch; and
deactivating the feedback switch to set the feedback path from the standby voltage node to the feedback node via a feedback resistor.

9. The method of claim 8, further comprising generating a first control voltage and a second control voltage based on the mode control signal, the method further comprising:
activating at least one output switch to couple the run voltage node and the standby voltage node via the first control voltage in the run mode;
deactivating the at least one output switch to decouple the run voltage node and the standby voltage node via the first control voltage in the standby mode; and
controlling the feedback switch via the second control voltage.

10. The method of claim 9, wherein generating the first control voltage and the second control voltage comprises generating the second control voltage to have a delayed rise time and a faster fall time relative to the first control voltage, and wherein controlling the feedback switch comprises activating the feedback switch subsequent to activating the at least one output switch in the run mode and deactivating the feedback switch prior to deactivating the at least one output switch in the standby mode.

11. A power regulator system comprising:
a mode control stage configured to set the power regulator system in one of a run mode and a standby mode;
a switching regulator configured to generate a regulator voltage at a regulator node based on a feedback voltage; and
an output stage comprising:
a first output switch interconnecting the regulator node and a run voltage node which is activated in the run mode and deactivated in the standby mode;
a second output switch interconnecting the run voltage node and a standby voltage node which is activated in the run mode and deactivated in the standby mode; and
a third output switch interconnecting the regulator node and the standby voltage node which is deactivated in the run mode and activated in the standby mode to provide the standby voltage independently of the run voltage.

12. The system of claim 11, further comprising a feedback stage configured to provide the feedback voltage based on the run voltage in the run mode and based on the standby voltage in the standby mode.

13. The system of claim 12, wherein the feedback control stage comprises:
a feedback switch that interconnects the run voltage node and a feedback node that is held at the feedback voltage, the feedback switch being activated in the run mode via the mode control stage to generate the feedback voltage based on the run voltage; and
a resistor that interconnects the standby voltage node and the feedback node.

14. The system of claim 13, wherein the mode control stage comprises:
a first inverter configured to generate a first control voltage based on the mode control signal, the first control voltage controlling the third output switch;
a second inverter configured to generate a second control voltage based on the first control voltage, the second control voltage controlling the first and second output switches; and
a third inverter that is powered by the second control voltage and which is configured to generate a third control voltage based on the first control voltage, the third control voltage controlling the feedback switch.

15. The system of claim 14, wherein the third inverter comprises a resistor and a capacitor that are selected to provide a delayed rise time and faster fall time of the third control voltage relative to the second control voltage, such that the third control voltage activates the feedback switch subsequent to the activation of the first and second output switches in the run mode and deactivates the feedback switch prior to the deactivation of the first and second output switches in the standby mode.
